(19) United States
(12) Patent Application Publication
(10) Pub. No.: US 2017/0147158 A1
(43) Pub. Date: May 25, 2017

(54) METHODS AND SYSTEMS FOR MANAGING GUI COMPONENTS IN A NETWORKED STORAGE ENVIRONMENT

(71) Applicant: NETAPP, INC., Sunnyvale, CA (US)

(72) Inventors: Pradip Mukhopadhyay, Bangalore (IN); Surekha Suram, Bangalore (IN); Rajeeb Panigrahi, Bangalore (IN); Lokesh Shah, Bangalore (IN); Sidhartha Sutar, Bangalore (IN)

(73) Assignee: NETAPP, INC., Sunnyvale, CA (US)

(21) Appl. No.: 14/946,553

(22) Filed: Nov. 19, 2015

(51) Int. Cl. G06F 3/0482; H04L 29/08; G06F 21/62; G06F 3/0484

(52) U.S. Cl. CPC G06F 3/0482; G06F 3/0484; H04L 67/1097; G06F 21/6218

(57) ABSTRACT

Methods and systems for a networked storage environment are provided. One method includes obtaining from a storage system a list of operations associated with data stored by the storage system that are permitted for a user based on a defined role of the user; using a first data structure to determine that a graphical user interface (GUI) component identified by a unique identifier and associated with an authorized operation should be enabled or disabled, wherein the first data structure stores unique identifiers for GUI components associated with specific operation types for the defined role; and storing the unique identifier of the GUI component with an indicator to enable or disable the GUI component for a specific operation in a cache for the user; wherein the cache is used to enable or disable the GUI component for another request from the user for performing the specific operation.

### TECHNICAL FIELD

The present disclosure relates to networked storage environments, and more particularly, to automated methods and systems for managing user interface components for storage related services.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple clients with access to shared data, backing up data and others.

A storage system typically includes at least a computing system executing a storage operating system for storing and retrieving data on behalf of one or more client computing systems (may just be referred to as “client” or “clients”). The storage operating system stores and manages shared data containers in a set of mass storage devices.

In a networked storage environment, various clients access storage space and storage resources. Different clients may have different roles that are associated with different permissions. The permissions enable a client to access data, write data, modify data and gather information regarding stored data as well as storage system resources.

A management console is typically used for managing storage services offered by a networked storage environment, like backup, restore, cloning and others. Often these services are accessed using GUI components. Continuous efforts are being made to better manage GUI components of a networked storage environment having a plurality of clients.

### BRIEF DESCRIPTION OF THE DRAWINGS

The various features of the present disclosure will now be described with reference to the drawings of the various aspects disclosed herein. In the drawings, the same components may have the same reference numerals. The illustrated aspects are intended to illustrate, but not to limit the present disclosure. The drawings include the following Figures:

FIG. 1A shows an example of a networked storage operating environment for implementing the various aspects of the present disclosure;

FIG. 1B shows a block diagram with the structure of a management application, according to one aspect of the present disclosure;

FIG. 2 shows an example of a networked, clustered storage system, used according to one aspect of the present disclosure;

FIGS. 3A-3B show process flow diagrams for managing graphical user interface components, according to one aspect of the present disclosure;

FIG. 4A shows an example of a storage operating system, used according to one aspect of the present disclosure;

FIG. 4B shows an example of a storage system node, according to one aspect of the present disclosure; and

FIG. 5 shows an example of a processing system, used according to one aspect of the present disclosure.

### DETAILED DESCRIPTION

As a preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a hardware processor, a hardware processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device, in accordance with the claimed subject matter.

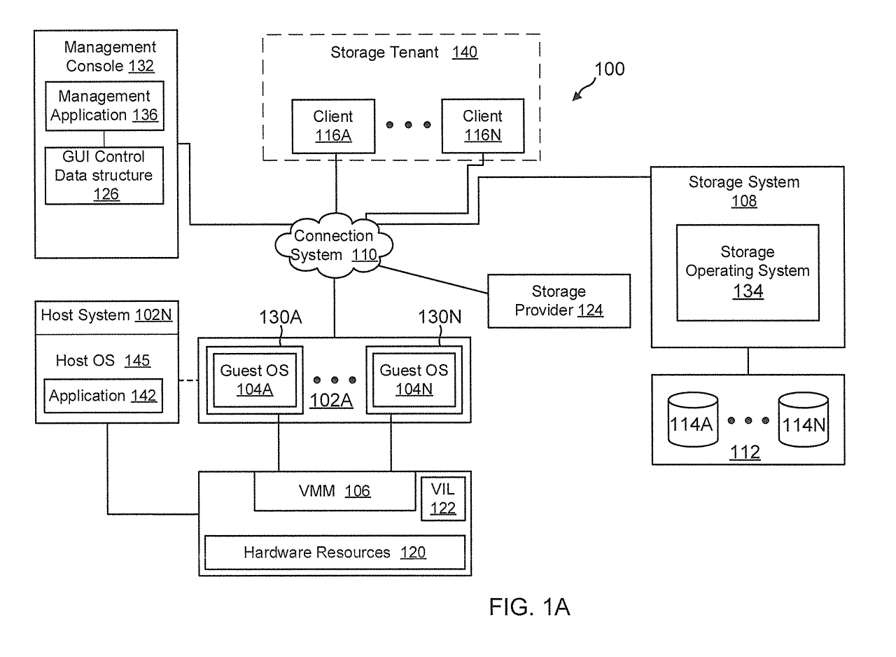

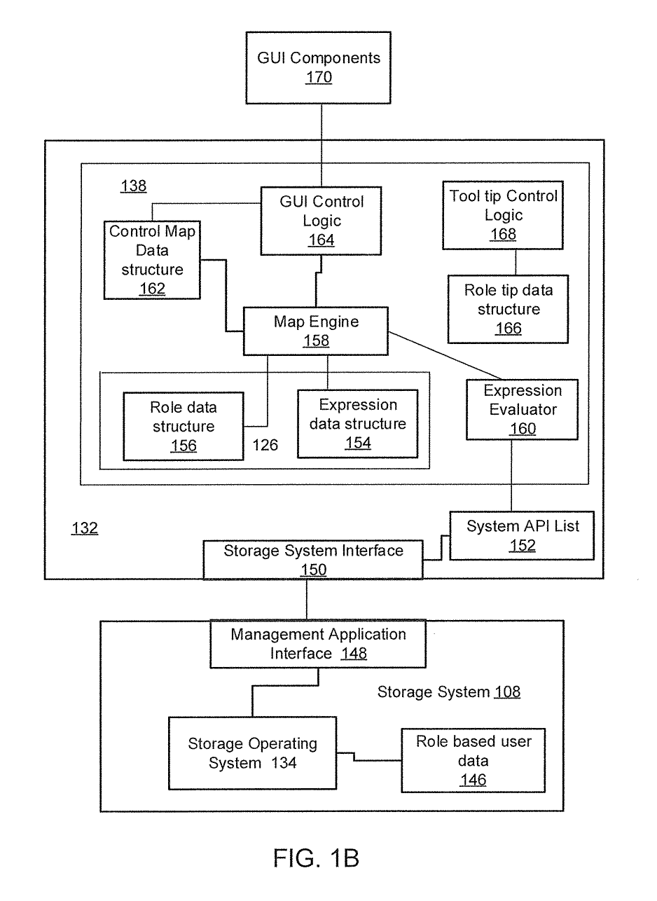

System 100: FIG. 1A shows an example of a networked storage environment 100 (also referred to as system 100) having a management console 132 executing a management application 136, according to one aspect of the present disclosure. Management application 136 uses or maintains a graphical user interface (GUI) control data structure 126 that is described below in detail.

System 100 may include a plurality of computing devices 102A-102N (may also be referred to individually as a host platform/system 102 or simply as server 102) communicably coupled to a storage system (or storage server) 108 that executes a storage operating system 134 via a connection system 110 such as a local area network (LAN), wide area network (WAN), the Internet and others. As described herein, the term “communicably coupled” may refer to a direct connection, a network connection, or other connections to enable communication between devices.

Management console 132 interfaces with the storage system 108 via the connection system 110. As an example, management console 132 may use Zephyr application programming interface (ZAPI) commands to request information from the storage system 108. The various adaptive aspects may be implemented using other command format or API types.

Host system 102A may execute a plurality of virtual machines (VMs) in a virtual environment that is described below in detail. Host system 102N may execute one or more application 142, for example, a database application (for example, Oracle application), an email application (Microsoft Exchange) and others. Host 102N also executes an operating system 145, for example, a Windows based operating system, Linux, Unix and others (without any derogation of any third party trademark rights).

Clients 116A-116N (may be referred to as client (or user) 116) are computing devices that can access storage space at the storage system 108. A client can be the entire system of a company, a department, a project unit or any other entity. Each client is uniquely identified and optionally, may be a part of a logical structure called a storage tenant 140. The storage tenant 140 represents a set of users (may be referred to as storage consumers) for a storage provider 124 (may also be referred to as a cloud manager, where cloud computing is being utilized). Where a storage provider 124 is being used, the client accesses storage and protection levels through the storage provider 124. It is noteworthy that the adaptive aspects of the present disclosure are not limited to using a storage provider 124 or a storage tenant and may be implemented for direct client access.

In one aspect, the storage provider 124 may establish different roles for users and tenants. Based on the role, certain workflows or operations have to be executed by the storage system 108 for providing storage related services based on the capabilities of the storage system 108. The workflow operations are requested by the management application 132 as ZAPI requests. In one aspect, the management application 132 enables and disables GUI components based on the user role and the associated workflow operations, as described below in detail.

In one aspect, storage system 108 has access to a set of mass storage devices 114A-114N (may be referred to as storage devices 114) within at least one storage subsystem 112. The mass storage devices 114 may include writable storage device media such as magnetic disks, video tape, optical, DVD, magnetic tape, non-volatile memory devices for example, solid state drives (SSDs) including self-encrypting drives, flash memory devices and any other similar media adapted to store information. The storage devices 114 may be organized as one or more groups of Redundant Array of Independent (or Inexpensive) Disks (RAID). The various aspects disclosed are not limited to any particular storage device type or storage device configuration.

The storage system 108 may provide a set of logical storage volumes (or logical unit numbers (LUNs)) that presents storage space to clients and VMs for storing information. Each volume may be configured to store data files (or data containers or data objects), scripts, word processing documents, executable programs, and any other type of structured or unstructured data. From the perspective of one of the client systems, each volume can appear to be a single drive. However, each volume can represent storage space in at one storage device, an aggregate of some or all of the storage space in multiple storage devices, a RAID group, or any other suitable set of storage space.

The storage operating system 134 organizes storage space at storage devices 114 as one or more “aggregate”, where each aggregate is identified by a unique identifier and a location. Within each aggregate, one or more storage volumes are created whose size can be varied. A qtree, sub-volume unit may also be created within the storage volumes. As a special case, a qtree may be an entire storage volume.

The storage system 108 may be used to store and manage information at storage devices 114 based on a request. The request may be based on file-based access protocols, for example, the Common Internet File System (CIFS) protocol or Network File System (NFS) protocol, over TCP/IP. Alternatively, the request may use block-based access protocols, for example, iSCSI and SCSI encapsulated over Fibre Channel (FCP).

In a typical mode of operation, a client transmits one or more input/output (I/O) commands, such as a CFS or NFS request, over connection system 110 to the storage system 108. Storage system 108 receives the request, verifies that the user is authorized to execute the command, issues one or more I/O commands to storage devices 114 to read or write the data on behalf of the client system, and issues a CIFS or NFS response containing the requested data over the network 110 to the respective client system.

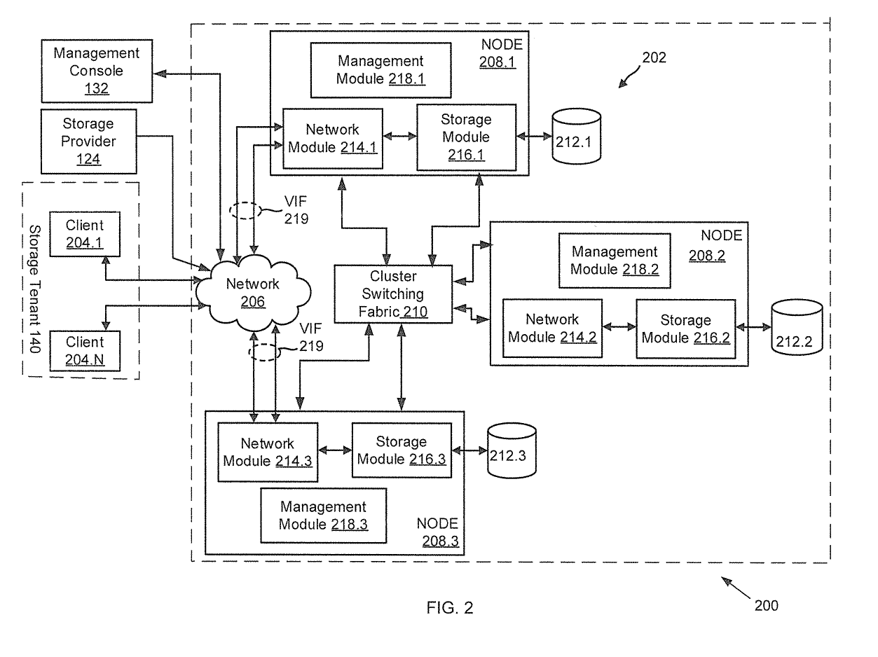

Although storage system 108 is shown as a stand-alone system, i.e. a non-cluster based system, in another aspect, storage system 108 may have a distributed architecture; for example, a cluster based system that is described below in detail with respect to FIG. 2.

As an example, system 100 may also include a virtual machine environment where a physical resource is time-shared among a plurality of independently operating processor executable virtual machines (VMs). Each VM may function as a self-contained platform, running its own operating system (OS) and computer executable, application software. The computer executable instructions running in a VM may be collectively referred to herein as “guest software.” In addition, resources available within the VM may be referred to herein as “guest resources.”

The guest software expects to operate as if it were running on a dedicated computer rather than in a VM. That is, the guest software expects to control various events and have access to hardware resources on a physical computing system (may also be referred to as a host platform) which maybe referred to herein as “host hardware resources”. The host hardware resource may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host platform.

Host platform 102A includes/provides a virtual machine environment executing a plurality of VMs 130A-130N that may be presented to client computing devices/systems 116A-116N. VMs 130A-130N execute a plurality of guest OS 104A-104N (may also be referred to as guest OS 104) that share hardware resources 120. Application 142 may be executed within VMs 130. As described above, hardware resources 120 may include storage, CPU, memory, I/O devices or any other hardware resource.

In one aspect, host platform 102A interfaces with a virtual machine monitor (VMM) 106, for example, a processor executed Hyper-V layer provided by Microsoft Corporation of Redmond, Wash., a hypervisor layer provided by VMWare Inc., or any other type. VMM 106 presents and manages the plurality of guest OS 104A-104N executed by the host platform 102. The VMM 106 may include or interface with a virtualization layer (VIL) 122 that provides one or more virtualized hardware resource to each OS 104A-104N.

In one aspect, VMM 106 is executed by host platform 102A with VMs 130A-130N. In another aspect, VMM 106 may be executed by an independent stand-alone computing system, referred to as a hypervisor server or VMM server and VMs 130A-130N are presented at one or more computing systems.

It is noteworthy that different vendors provide different virtualization environments, for example, VMware Corporation, Microsoft Corporation and others. Data centers may have hybrid virtualization environments/technologies, for example, Hyper-V and hypervisor based virtual environment. The generic virtualization environment described above with respect to FIG. 1A may be customized depending on the virtual environment to implement the aspects of the present disclosure. Furthermore, VMM 106 (or VIL 122) may execute other modules, for example, a storage driver, network interface and others, the details of which are not germane to the aspects described herein and hence have not been described in detail.

Management Application 136: FIG. 1B shows an example of the architecture of management application 136, according to one aspect of the present disclosure. The management application 136 is used to monitor resources of system 100, interface with storage system 108 and obtain information regarding resources used in system 100. Management application 136 may also be used to coordinate storage services, for example, backup, restore, cloning and others.

In one aspect, management application 136, presents a GUI to a user. The GUI or GUI components that are displayed within the GUI are controlled by role based access control (RBAC). Under RBAC, each user is assigned a certain role. Each role is associated with certain capabilities or attributes, for example, to create, update delete or read a data container, obtain information regarding data containers stored by the storage system, perform backups, restore or perform deduplication operations, store data using certain encryption types, and other aspects. In one aspect, roles are pre-defined or roles may be created based on user needs.

The storage system 108 stores RBAC information for users at data structure 146. Data structure 146 stores the role associated with a user, the corresponding permissions and attributes. Data structure 146 may be used by storage operating system 134 to provide RBAC information to management application 136 via a management application interface 148. The responses from the storage system 108 may be in the ZAPI format.

The management application 136 uses a storage system interface 150 to request user RBAC information. The information is provided as a system.API.list 152 (may be referred to as data structure 152) and then stored at a storage location accessible to management application 136. The data structure 152 is used by the GUI control module 138, described below in detail.

The GUI control module 138 maintains the GUI control data structure 126 and accesses data structure 152 for providing role based GUI components 170 to a user. The GUI components 170 (for example, a button, a grid or a tab) are associated with a role/workflow operations and displayed by a GUI control logic 164. In one aspect, the GUI control data structure 126 includes one or more data structure, for example, a role data structure 156 (may be referred to as data structure 156), an expression properties data structure 154 (may be referred to as data structure 154) and a role tip properties data structure 166 (may be referred to as data structure 166) that are described below in detail. The role tip data structure 166 is not shown within the data structure 126 block for convenience but functionally may be part of the data structure 126. The different data structures are shown as an example only and may be consolidated into a single structure.

In one aspect, the role data structure 156 is a properties file with enumerated values as keys to uniquely identify each GUI component and provide a True or False value as a Boolean value.

The data structure 154 is also a properties file which includes enumerated values to uniquely identify each GUI component with a ZAPI expression. When the management application 136 sends a ZAPI request for information, the request may have multiple aspects depending on the request. These aspects are referred to as ZAPI expressions. For example, to move a storage volume from one storage system node to another will have an associated workflow. The different workflow components are then represented by different ZAPI expressions. The GUI components are enabled based on these different, authorized ZAPI expressions.

The data structure 166 is a properties file which includes enumerated values as key and tooltip message as a value. The data structure is used for customizing a tooltip for disabled GUI components.

In one aspect, the GUI control module 138 includes a control map 162 that stores a collection of key value pairs, for example, a Widget-ID and a true or false value. Each Widget-ID is associated with a GUI component and uniquely identifies the component. When the Widget-ID is true, the component is enabled, otherwise it is disabled. In one aspect, the control map data structure 162 is stored within a cache of the management console 132. The cache is used to determine what GUI component is enabled or disabled, as described below in detail.

In one aspect, the GUI control module 138 includes a map engine 158 that populates the control map 162 using data structures 156 and 154. An expression evaluator 160 takes the system.APi list 152 and populates data structure 154. As mentioned above, each GUI component is assigned a unique identifier. When a user logs in, then a list of ZAPIs for which the user has permission to execute are obtained from the storage system 108 and stored at data structure 152.

When a GUI component is added for the first time, the Widget-ID is searched at the control map 162. When the Widget-ID is not found in the control map 162, then the Widget-ID is searched at data structure 154. Every GUI component that is role aware has a corresponding entry at data structure 154. An example of an entry is as follows:

VolumesToolbarDpBtn=(sis-get) && (sis-start∥sis-stop)

Where: VolumesToolbarDpBtn is the Widget-ID for a deduplication GUI button from a storage volume page. (SIS-Get) && (SIS-Start∥sis-stop) are the ZAPI expressions that mean to get a single storage instance (SIS).

Continuing with the foregoing example, the deduplication button is enabled when the logged in user has permission to execute the SIS-Get operation using a ZAPI call and if either the SIS-start and SIS-stop ZAPI calls are available.

The expression evaluator 160 evaluates the ZAPI expression based on data structure 152. The expression evaluator 160 provides a true or false output depending on the ZAPI availability. Once the expression is evaluated, the Widget-ID and true or false value is stored by the map engine 158 at the control map 162. Next time, when the same GUI component is used, then the control map 162 is used by the control logic 164 to display the appropriate GUI components.

If the Widget-ID for example for the deduplication button is not found at data structure 154, then the data structure 156 is invoked. Data structure may store an entry in the following format:

UIControl_<role-name>.properties.file snippet: VolumesToolbarDpBtn=TRUE/FALSE

Data structure 156 either returns a true or false value for the Widget-ID to the map engine 158. Based on the returned value, the associated GUI component is either enabled or disabled.

Similar to data structures 154 and 156, data structure 166 stores role-tooltip.properties. The data structure 166 stores a collection of enumerated key value pairs stored as keys and mapped to Widget-ID to represent the tooltip for a GUI component.

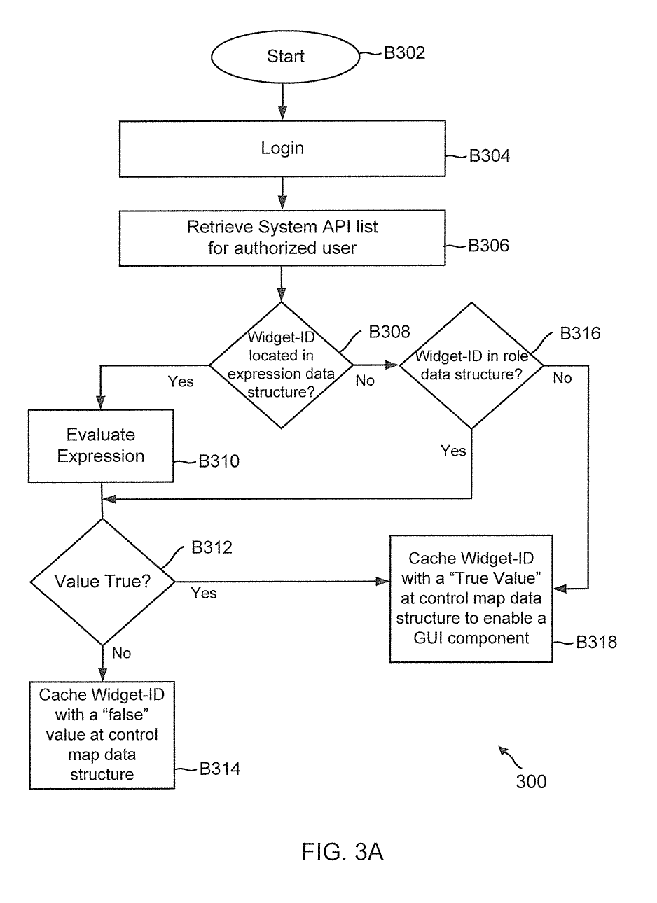

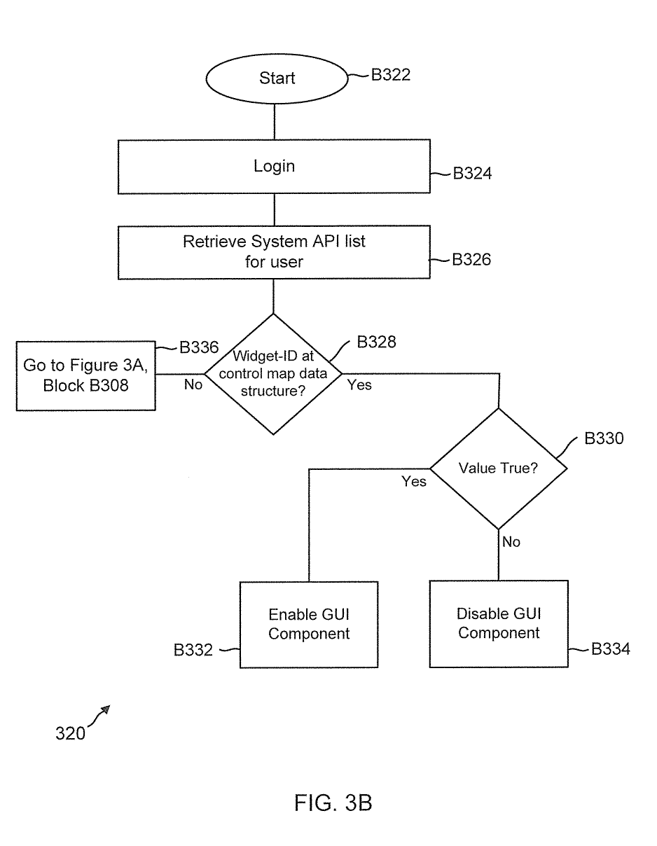

In one aspect, the system and methods disclosed herein express a workflow that is accomplished using one or more GUI component. The workflow is expressed in a non-canonical expression of ZAPI calls. The various methods for using the GUI control module 138 is described below with respect to FIGS. 3A and 3B, after a cluster based storage environment is described.

Clustered System: FIG. 2 shows a cluster based storage environment 200 having a plurality of nodes operating as resources to store data on behalf of clients. System 200 includes the management console 132 with the management application 136 described above in detail.

Storage environment 200 may include a plurality of client systems 204.1-204.N as part of or associated with storage tenant 140, a clustered storage system 202 (similar to storage system 108) and at least a network 206 communicably connecting the client systems 204.1-204.N, the management console 132, the storage provider 124 and the clustered storage system 202. It is noteworthy that these components may interface with each other using more than one network having more than one network device.

The clustered storage system 202 includes a plurality of nodes 208.1-208.3, a cluster switching fabric 210, and a plurality of mass storage devices 212.1-212.3 (may be referred to as 212 and similar to storage device 114). Each of the plurality of nodes 208.1-208.3 is configured to include a network module, a storage module, and a management module, each of which can be implemented as a processor executable module. Specifically, node 208.1 includes a network module 214.1, a storage module 216.1, and a management module 218.1, node 208.2 includes a network module 214.2, a storage module 216.2, and a management module 218.2, and node 208.3 includes a network module 214.3, a storage module 216.3, and a management module 218.3.

The network modules 214.1-214.3 include functionality that enable the respective nodes 208.1-208.3 to connect to one or more of the client systems 204.1-204.N (or the management console 132) over the computer network 206. The network modules handle file network protocol processing (for example, CFS, NFS and/or iSCSI requests). The storage modules 216.1-216.3 connect to one or more of the storage devices 212.1-212.3 and process I/O requests. Accordingly, each of the plurality of nodes 208.1-208.3 in the clustered storage server arrangement provides the functionality of a storage server.

The management modules 218.1-218.3 provide management functions for the clustered storage system 202. The management modules 218.1-218.3 collect storage information regarding storage devices 212 and makes it available to management application 136.

A switched virtualization layer including a plurality of virtual interfaces (VIFs) 219 is provided to interface between the respective network modules 214.1-214.3 and the client systems 204.1-204.N, allowing storage 212.1-212.3 associated with the nodes 208.1-208.3 to be presented to the client systems 204.1-204.N as a single shared storage pool.

The clustered storage system 202 can be organized into any suitable number of storage virtual machines (SVMs) (may be referred to as virtual servers (may also be referred to as “SVMs”), in which each SVM represents a single storage system namespace with separate network access. A SVM may be designated as a resource on system 200. Each SVM has a client domain and a security domain that are separate from the client and security domains of other SVMs. Moreover, each SVM is associated with one or more VIFs 219 and can span one or more physical nodes, each of which can hold one or more VIFs and storage associated with one or more SVMs. Client systems can access the data on a SVM from any node of the clustered system, through the VIFs associated with that SVM.

Each of the nodes 208.1-208.3 is defined as a computing system to provide application services to one or more of the client systems 204.1-204.N. The nodes 208.1-208.3 are interconnected by the switching fabric 210, which, for example, may be embodied as a Gigabit Ethernet switch or any other type of switching/connecting device.

Although FIG. 2 depicts an equal number (i.e., 3) of the network modules 214.1-214.3, the storage modules 216.1-216.3, and the management modules 218.1-218.3, any other suitable number of network modules, storage modules, and management modules may be provided. There may also be different numbers of network modules, storage modules, and/or management modules within the clustered storage system 202. For example, in alternative aspects, the clustered storage system 202 may include a plurality of network modules and a plurality of storage modules interconnected in a configuration that does not reflect a one-to-one correspondence between the network modules and storage modules. In another aspect, the clustered storage system 202 may only include one network module and storage module.

Each client system 204.1-204.N may request the services of one of the respective nodes 208.1, 208.2, 208.3, and that node may return the results of the services requested by the client system by exchanging packets over the computer network 206, which may be wire-based, optical fiber, wireless, or any other suitable combination thereof.

Process Flow: FIG. 3A shows a process 300 executed by the GUI control module 138, according to one aspect of the present disclosure. The process begins in block B302, when the storage system 108, a user system (for example, 116, 204) and the management console 132 are initialized and operational.

In block B304, a user logins using a login module provided by the management console 132. The login module is provided so that the user can be authenticated. The user credentials (for example, a user ID, a password and/or other authentication credentials) are entered. The management console 132 maintains a data structure (not shown) of user credentials to authenticate the user. In another aspect, the user is authenticated by the storage system 108.

After the user credentials are authenticated, in block B306, a request is sent to retrieve a list of ZAPIs that the user is permitted to execute. This information is retrieved from the storage system 108 and then stored at data structure 152. Information from data structure 152 is retrieved and stored at data structure 154.

In block B308, the data structure 154 is searched to determine if a particular GUI component ID (or Widget-ID) exists at data structure 154. If yes, then in block B310, the expression evaluator 160 evaluates the expression's value for the Widget-ID. In block B312, the expression evaluator 160 determines if the value is true. If true, then in block B318, the Widget-ID and the associated value is stored at the control map 162 by the map engine 158 to enable the GUI component for that user. If the value is not true, then in block B314, the Widget-ID is stored with a “false” value so that the GUI component associated with the Widget-ID is disabled i.e. not made available to the user.

If in block B308, the Widget-ID is not found in data structure 154, then the data structure 156 is searched to determine if the GUI component is part of that data structure. If yes, then the process moves to block B312 that is described above. If not, the process moves to block B318 that is also described above.

FIG. 3B shows a process 320 for using the control map data structure 162, according to one aspect of the present disclosure. The process begins in block B322, similar to block B302 described above. In block B324, the user logs in similar to block B304, also described above. The ZAPI list is retrieved in block B326, similar to block B306 also described above.

In block B328, the control map 162 is searched by the map engine 158 to determine if the Widget-ID is already cached. If yes, then in block B330, the map engine 158 determines if the value is true. If true, then the GUI component is enabled in block B332, otherwise, in block B334, the component is disabled.

If the Widget-ID is not found in the control map, then in block B336, the process moves to block B308 of FIG. 3A, described above in detail.

In one aspect, an automated, GUI component management system and process is provided. Roles and associated operations are tied with GUI components. Only authorized operations and the GUI components are provided to the user.

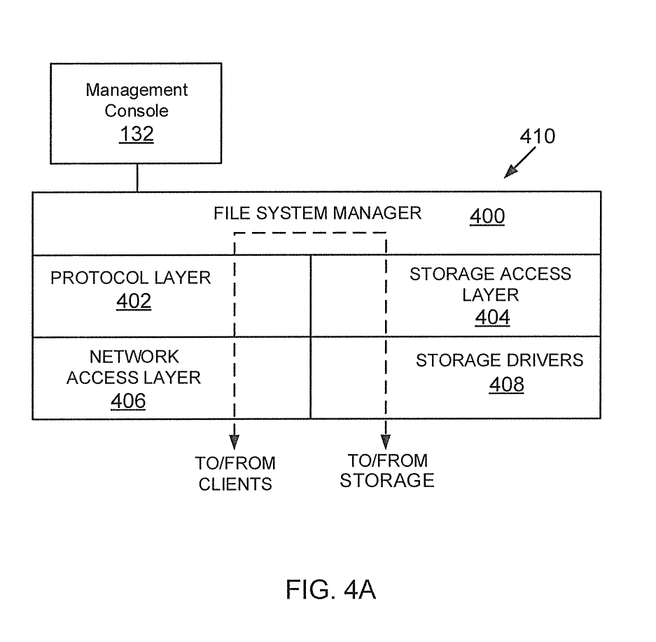

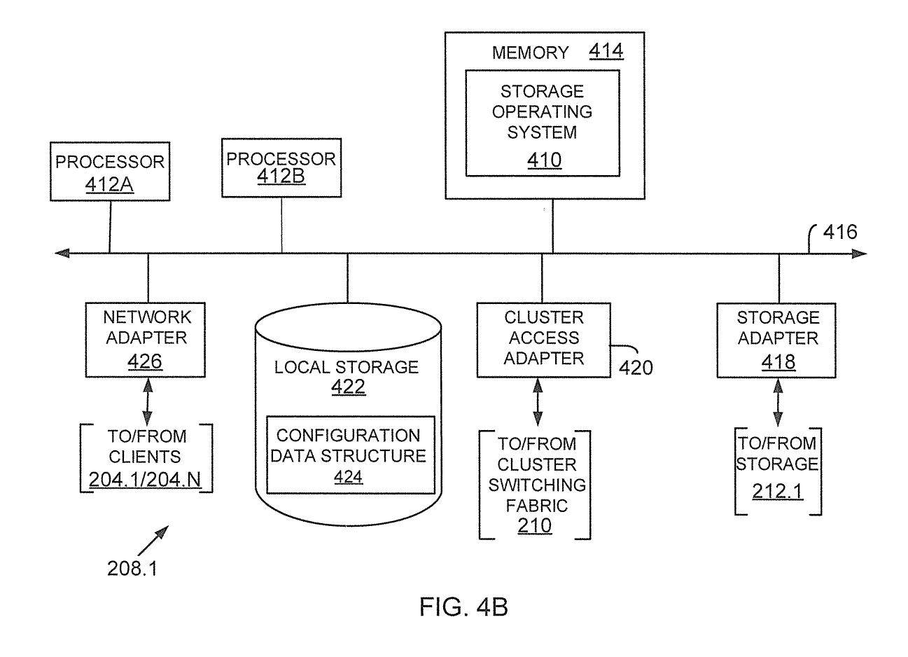

Operating System: FIG. 4A illustrates a generic example of storage operating system 410 (or 134, FIG. 1A) executed by node 208.1, according to one aspect of the present disclosure. The storage operating system 410 interfaces with the management console 132 and provides information regarding different operations that are authorized for a user. The storage operating system 410 provides the information for data structure 152 described above in detail.

In one example, storage operating system 410 may include several modules, or “layers” executed by one or both of network module 214 and storage module 216. These layers include a file system manager 400 that keeps track of a directory structure (hierarchy) of the data stored in storage devices and manages read/write operation, i.e. executes read/write operation on storage in response to client 204.1/204.N requests.

Storage operating system 410 may also include a protocol layer 402 and an associated network access layer 406, to allow node 208.1 to communicate over a network with other systems, such as clients 204.1/204.N. Protocol layer 402 may implement one or more of various higher-level network protocols, such as NFS, CIFS, Hypertext Transfer Protocol (HTTP), TCP/IP and others.

Network access layer 406 may include one or more drivers, which implement one or more lower-level protocols to communicate over the network, such as Ethernet. Interactions between clients' and mass storage devices 212.1-212.3 (or 114) are illustrated schematically as a path, which illustrates the flow of data through storage operating system 410.

The storage operating system 410 may also include a storage access layer 404 and an associated storage driver layer 408 to allow Storage module 216 to communicate with a storage device. The storage access layer 404 may implement a higher-level storage protocol, such as RAID (redundant array of inexpensive disks), while the storage driver layer 408 may implement a lower-level storage device access protocol, such as FC or SCSI. The storage driver layer 408 may maintain various data structures (not shown) for storing information regarding storage volume, aggregate and various storage devices.

As used herein, the term “storage operating system” generally refers to the computer-executable code operable on a computer to perform a storage function that manages data access and may, in the case of a node 208.1, implement data access semantics of a general purpose operating system. The storage operating system can also be implemented as a microkernel, an application program operating over a general-purpose operating system, such as UNIX® or Windows XP®, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly-attached to a client or host computer. The term “storage system” should therefore be taken broadly to include such arrangements in addition to any subsystems configured to perform a storage function and associated with other equipment or systems. It should be noted that while this description is written in terms of a write any where file system, the teachings of the present disclosure may be utilized with any suitable file system, including a write in place file system.

Storage System Node: FIG. 4B is a block diagram of a node 208.1 that is illustratively embodied as a storage system comprising of a plurality of processors 412A and 412B, a memory 414, a network adapter 426, a cluster access adapter 420, a storage adapter 418 and local storage 422 interconnected by a system bus 416. Node 208.1 may be used to provide information regarding authorized operations to management console 132. The information is then stored at data structure 152 for executing the process flows described above.

Processors 412A-412B may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware devices. The local storage 422 comprises one or more storage devices utilized by the node to locally store configuration information for example, in a configuration data structure 424.

The cluster access adapter 420 comprises a plurality of ports adapted to couple node 208.1 to other nodes of cluster 100. In the illustrative aspect, Ethernet may be used as the clustering protocol and interconnect media, although it will be apparent to those skilled in the art that other types of protocols and interconnects may be utilized within the cluster architecture described herein. In alternate aspects where the network modules and storage modules are implemented on separate storage systems or computers, the cluster access adapter 420 is utilized by the network/storage module for communicating with other network/storage modules in the cluster 100.

Each node 208.1 is illustratively embodied as a dual processor storage system executing a storage operating system 410 (similar to 134, FIG. 1A) that preferably implements a high-level module, such as a file system, to logically organize the information as a hierarchical structure of named directories and files on storage 212.1. However, it will be apparent to those of ordinary skill in the art that the node 208.1 may alternatively comprise a single or more than two processor systems. Illustratively, one processor 412A executes the functions of the network module 214 on the node, while the other processor 412B executes the functions of the storage module 216.

The memory 414 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the disclosure described herein.

The storage operating system 410 portions of which is typically resident in memory and executed by the processing elements, functionally organizes the node 208.1 by, inter alia, invoking storage operation in support of the storage service implemented by the node.

The network adapter 426 comprises a plurality of ports adapted to couple the node 208.1 to one or more clients 204.1/204.N over point-to-point links, wide area networks, virtual private networks implemented over a public network (Internet) or a shared local area network. The network adapter 426 thus may comprise the mechanical, electrical and signaling circuitry needed to connect the node to the network. Illustratively, the computer network 206 may be embodied as an Ethernet network or a Fibre Channel network. Each client 204.1/204.N may communicate with the node over network 206 by exchanging discrete frames or packets of data according to pre-defined protocols, such as TCP/IP.

The storage adapter 418 cooperates with the storage operating system 410 executing on the node 208.1 to access information requested by the clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is preferably stored on storage device 212.1. The storage adapter 418 comprises a plurality of ports having input/output (I/O) interface circuitry that couples to the storage devices over an I/O interconnect arrangement, such as a conventional high-performance, FC link topology.

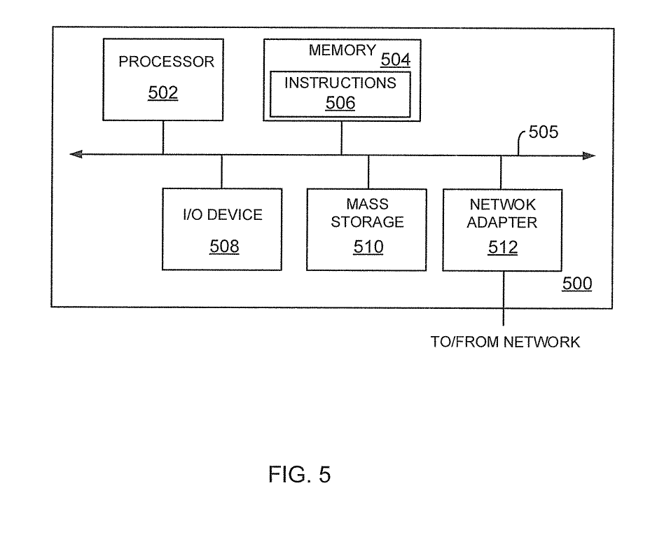

Processing System: FIG. 5 is a high-level block diagram showing an example of the architecture of a processing system 500 that may be used according to one aspect. The processing system 500 can represent host system 102, management console 132, clients 116, 204 or storage system 108. Note that certain standard and well-known components which are not germane to the present aspects are not shown in FIG. 5.

The processing system 500 includes one or more processor(s) 502 and memory 504, coupled to a bus system 505. The bus system 505 shown in FIG. 5 is an abstraction that represents any one or more separate physical buses and/or point-to-point connections, connected by appropriate bridges, adapters and/or controllers. The bus system 505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 502 are the central processing units (CPUs) of the processing system 500 and, thus, control its overall operation. In certain aspects, the processors 502 accomplish this by executing software stored in memory 504. A processor 502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 504 represents any form of random access memory (RAM), read-only memory (ROM), flash memory, or the like, or a combination of such devices. Memory 504 includes the main memory of the processing system 500. Instructions 506 may be used to implement the process steps of FIGS. 3A and 3B described above may reside in and execute (by processors 502) from memory 504. Data structures 152, 154, 156 and 166 may also be stored at memory 504.

Also connected to the processors 502 through the bus system 505 are one or more internal mass storage devices 510, and a network adapter 512. Internal mass storage devices 510 may be, or may include any conventional medium for storing large volumes of data in a non-volatile manner, such as one or more magnetic or optical based disks. The network adapter 512 provides the processing system 500 with the ability to communicate with remote devices (e.g., storage servers) over a network and may be, for example, an Ethernet adapter, a Fibre Channel adapter, or the like.

The processing system 500 also includes one or more input/output (I/O) devices 508 coupled to the bus system 505. The I/O devices 508 may include, for example, a display device, a keyboard, a mouse, etc.

Thus, a method and apparatus for managing GUI components have been described. Note that references throughout this specification to “one aspect” (or “embodiment”) or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A machine implemented method, comprising:
obtaining by a processor of a management console from a storage system a list of operations associated with data stored by the storage system that are permitted for a user based on a defined role of the user;
using by the processor, a first data structure to determine that a graphical user interface (GUI) component identified by a unique identifier and associated with an authorized operation should be enabled or disabled, wherein the first data structure stores unique identifiers for GUI components associated with specific operation types for the defined role; and
storing the unique identifier of the GUI component with an indicator to enable or disable the GUI component for a specific operation in a cache for the user; wherein the cache is used to enable or disable the GUI component for another request from the user for performing the specific operation.

2. The method of claim 1, wherein when the unique identifier for the GUI component is unavailable at the first data structure, then using by the processor, a second data structure to ascertain whether the GUI component is to be enabled or disabled, where the second data structure stores an indicator to enable or disable the GUI component for the defined role.

3. The method of claim 1, wherein the list of operations are part of a workflow defined by a plurality of application programming interface (API) requests that are sent by the management console to the storage system.

4. The method of claim 1, wherein the storage system maintains a data structure storing permissions associated with the defined role for the user.

5. The method of claim 1, wherein the list of operations is obtained from the storage system after the user has successfully logged into the management console.

6. The method of claim 1, wherein the management application uses Zephyr application programming interface (ZAPI) requests for obtaining the list of operations.

7. The method of claim 6, wherein the first data structure is populated based on information received from the storage system.

8. A non-transitory, machine readable medium having stored thereon instructions comprising machine executable code which when executed by a machine, causes the machine to:
obtain by a processor of a management console from a storage system a list of operations associated with data stored by the storage system that are permitted for a user based on a defined role of the user;
use by the processor, a first data structure to determine that a graphical user interface (GUI) component identified by a unique identifier and associated with an authorized operation should be enabled or disabled, wherein the first data structure stores unique identifiers for GUI components associated with specific operation types for the defined role; and
store the unique identifier of the GUI component with an indicator to enable or disable the GUI component for a specific operation in a cache for the user; wherein the cache is used to enable or disable the GUI component for another request from the user for performing the specific operation.

9. The non-transitory, storage medium of claim 8, wherein when the unique identifier for the GUI component is unavailable at the first data structure, then using by the processor, a second data structure to ascertain whether the GUI component is to be enabled or disabled, where the second data structure stores an indicator to enable or disable the GUI component for the defined role.

10. The non-transitory, storage medium of claim 8, wherein the list of operations are part of a workflow defined by a plurality of application programming interface (API) requests that are sent by the management console to the storage system.

11. The non-transitory, storage medium of claim 8, wherein the storage system maintains a data structure storing permissions associated with the defined role for the user.

12. The non-transitory, storage medium of claim 8, wherein the list of operations is obtained from the storage system after the user has successfully logged into the management console.

13. The non-transitory, storage medium of claim 8, wherein the management application uses Zephyr application programming interface (ZAPI) requests for obtaining the list of operations.

14. The non-transitory, storage medium of claim 13, wherein the first data structure is populated based on information received from the storage system.

15. A system, comprising:
a memory containing machine readable medium comprising machine executable code having stored thereon instructions; and a processor module of a management console coupled to the memory, the processor module configured to execute the machine executable code to:
obtain by from a storage system a list of operations associated with data stored by the storage system that are permitted for a user based on a defined role of the user;
use a first data structure to determine that a graphical user interface (GUI) component identified by a unique identifier and associated with an authorized operation should be enabled or disabled, wherein the first data structure stores unique identifiers for GUI components associated with specific operation types for the defined role; and
store the unique identifier of the GUI component with an indicator to enable or disable the GUI component for a specific operation in a cache for the user; wherein the cache is used to enable or disable the GUI component for another request from the user for performing the specific operation.

16. The system of claim 15, wherein when the unique identifier for the GUI component is unavailable at the first data structure, then using by the processor, a second data structure to ascertain whether the GUI component is to be enabled or disabled, where the second data structure stores an indicator to enable or disable the GUI component for the defined role.

17. The system of claim 15, wherein the list of operations are part of a workflow defined by a plurality of application programming interface (API) requests that are sent by the management console to the storage system.

18. The system of claim 15, wherein the storage system maintains a data structure storing permissions associated with the defined role for the user.

19. The system of claim 15, wherein the list of operations is obtained from the storage system after the user has successfully logged into the management console.

20. The system of claim 15, wherein the management application uses Zephyr application programming interface (ZAPI) requests for obtaining the list of operations.
